(19) United States
(12) Patent Application Publication
(10) Pub. No.: US 2002/0195834 A1
(43) Pub. Date: Dec. 26, 2002

(54) Chrome-plated pad-printed object and method for printing on a chrome plated object

(76) Inventor: Ken Ilkka, Clinton TWP, MI (US)

Correspondence Address: Welsh & Katz, Ltd., Jeffrey W. Salmon, 22nd Floor, 120 South Riverside Plaza, Chicago, IL, 60606, US

(21) Appl. No.: 09/886,886

(22) Filed: Jun. 21, 2001

(51) Int. Cl. B60J 5/00

(52) U.S. Cl. 296/146.7

(57) ABSTRACT

A chrome plated item with printing and the method of printing on chrome plated items is provided. The method includes the steps of providing a plastic molded part having chrome plated thereon and pad printed images, icons, indicia and/or instructions printed on the chrome plating. In a preferred embodiment the item is an automobile part and the pad printing process includes the use of agitated ink placed on the part using a stamp or die having indicia, icons and instructions thereon. The ink, used in the preferred embodiment, is agitated immediately prior to its placement on an inkpad and immediately prior to the placement of a stamp onto the inkpad and then onto the part, to imprint the part.

### FIELD OF THE INVENTION

The present invention concerns a chrome-plated object and a method of printing with ink onto chrome plated parts. More particularly the present invention is directed to plastic molded chrome plated automobile parts and a manner of printing icons, directions and other indicia of usage or origin onto chrome plated plastic and metal parts for use in the automotive industry.

### BACKGROUND OF THE INVENTION

Chrome plated parts have been a large part of the automotive industry for many years. Cyclically, in response to fashion-like trends, automobiles will be constructed with considerable numbers of chrome plated parts for both decorative and protective purposes. Generally, however, in any model year, many parts used in the interiors and on the exteriors of vehicles, will be chrome plated.

It has been a trend in the automotive industry to provide instructions, warnings and helpful icons or indicia on parts to assist the user in the safe use of their automobile. Such warnings labels as “Unleaded Fuel Only”, “Premium Grade Fuel Only”, “Objects In Mirror Are Closer Than They Appear”, or informational labels as “Supplemental Restraint System” and/or “Anti-lock Brake System”, and/or icons showing the location of keyholes, and words indicating the direction of action of power window and door lock activation push buttons, are often imprinted on automobile parts. It has, however, not generally been possible to print such indicia onto chrome or chrome plated parts as printing methods currently in use produce poor results, due to the generally frictionless, non-adhesive and non-porous nature of chrome, and because such printing is easily removed through normal wear, thereby not meeting strict industry and governmental standards for markings. As a result, chrome plating, while desirable and giving a luxurious impression to the users has not been available for parts necessitating printed instructions or indicia.

While pad printing on chrome plated parts has been attempted in the past, it has been found that such printings are not long lasting and may easily be removed from the part in the normal course of usage of the printed object. As such, attempts at printing on chrome have not met stringent industry and government standards for marking on parts.

We have invented a new process by which printing of informational and other indicia may be placed, in accordance with industry and government standards, onto chrome and chrome plated products. We have also invented devices, which are chrome plated, and have, printed thereon, indicia, icons and/or instructions for use.

### SUMMARY OF THE INVENTION

In accordance with the present invention, a part is molded from plastic and is chrome plated. The part is then printed, using a pad printing process, using ink that has been agitated, to industry standards. In a preferred embodiment the part is an automobile part. In a further preferred embodiment, the part is injection molded and then painted with chrome or chrome colored paint. The preferred ink for use in a process of the present invention is ZK ink. In a preferred embodiment, the ink is number 1/0-ZK-9016, ink that can be secured from Service Tech. Industries of Michigan, and that is produced by Ruco Drüch Farben, AG of Germany. It is to be understood that other inks having similar qualities may be used, by persons having skill in the art, without departing from the novel scope of the present invention. Ink for use in the present invention is preferably mixed, in desirable proportions, with an epoxy or other adhesion agent and a hardening substance, such that the agitation step of the printing process mixes the agents for ideal color, durability and adhesion.

The automobile part is printed using a pad printing process which includes the use of a pad and a stamp or die, having indicia. The stamp, or die, is inked on the pad and pressed against the part, to print on the part, immediately after agitated ink has been placed on the pad. In a preferred embodiment, the stamp or die is placed twice on the part so as to provide a clear and dark impression on the part. In one embodiment, the stamp is inked then placed on the part, leaving an impression, is re-inked and then re-applied to the part, providing a particularly dark impression.

The present invention includes a method of printing on an automobile part, comprising the steps of producing an automobile part, plating the automobile part with chrome, providing a stamp having indicia cut therein, providing ink, and applying the ink to the stamp and pressing the stamp onto the part. The preferred embodiment, of the method of the present invention, includes the step of agitating the ink immediately prior to applying the ink to the stamp and applying the stamp to the part. In the preferred embodiment, a mixture of 60% epoxy inks (that is ink having a mixture including an epoxy formulation) and 40% hardener is used. Further, in a preferred embodiment, the ink is applied using a rubber tipped applicator, subsequent to the completion of the printing process the item can be cured. A preferred method of curing an item printed in accordance with the teachings of the present invention, includes placing the item on a conveyor and feeding the conveyor through an annealing device which includes subjecting the printed item to a temperature between 250° and 260° Fahrenheit for between 2 and 3 minutes. In a preferred embodiment, the printed item is cured in a dryer, or other device, at a temperature of 258° Fahrenheit for 2.5 minutes. It is to be understood that variations of time and temperature in curing the printed items may be made without departing from the novel scope of the present invention. In a preferred embodiment of the present invention, an infrared lamp device is used to cure a pad-printed item. It will, however, be understood that different types of devices, ovens, blowers or other curing means can be used by persons having skill in the art, without departing from the novel scope of the present invention. In a further embodiment of the present invention, a chrome-plated part is first given an acid bath, prior to stamping, so as to etch the part to allow better adhesion with stamping ink. The part is further wiped down with a residue free cloth and is then brought to the printing apparatus.

A more detailed explanation of the invention is provided in the following description and claims and is illustrated in the accompanying drawings.

### BRIEF DESCRIPTION OF THE DRAWINGS

FIG. 1 is schematic representation of the process of the present invention.

FIG. 2 is a perspective view of a part made in accordance with the teaching of the present invention.

FIG. 3 is a perspective view of the part of FIG. 2 placed on an automobile door.

FIG. 4 is a schematic representation of an alternative process of the present invention.

### DETAILED DESCRIPTION OF THE ILLUSTRATIVE EMBODIMENT

While the present invention is susceptible of embodiment in various forms, there are shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of an Illustrative Embodiment”) relates to a requirement of the United States Patent Office, and should not be found to limit the subject matter disclosed herein.

Referring to the drawings, a molding process utilizing a mold 10 is used to prepare a part 12, typically an automobile part. It is to be understood that the molding process may be of any type of molding process known in the art and particularly in the automobile molding art, including injection molding, blow molding, and compression molding. Once a part 12 is molded, the part may be plated with chrome 14 either at the place where molding has occurred or at a remote location. Typically, such plastics as ABS and PCABS alloys may be molded and then plated with chrome. Further items of metal may be made using casting processes or other processes known in the art, and then plated with chrome. Subsequent to plating, part 12 can then be printed upon. In the preferred embodiment of the present invention, printing is accomplished through a pad printing process 16. It is to be understood that printing of any sort known to the art may be utilized, without departing from the novel scope of the present invention.

Typically, in the past, pad printing 16 has been accomplished by the placement of ink onto a soft absorbent ink pad, a stamp, having an image or words cut into, typically, a rubber die, is pressed onto the pad causing ink to transfer to the rubber die of the stamp from the absorbent pad. The inked rubber die of the stamp is then pressed, or placed, onto the object to be printed and an image is transferred onto the object. Inks having a ratio of 90% epoxy ink to 10% hardener have been used in the past, but have produced poor results. It has been found that such processes do not produce printed images that are compatible with government or industry standards and requirements.

In the present invention a source of ink 20 is provided such that ink 22 may be placed into the source and the source may be continually agitated so as to prevent suspended particulates in the ink from separating from the fluid of ink 22. In a preferred embodiment of the present invention ZK ink 22 is utilized due to properties that make it ideal for pad printing on objects. Ink 22, of the preferred embodiment, is mixed in the following ratio: 60% epoxy ink formula to 40% hardening substance. It is to be understood that other types and kinds of ink, paint or other marking products, having similar properties, may be used, by persons having skill in the art without departing from the novel scope of the present invention. Agitation of ink 22 may be accomplished by any method known in the art and practiced by persons having skill in the art without departing from the novel scope of the present invention. The use of ZK ink 22 and the agitation procedure of the present invention causes ink impressions that meet industry and government standards. Further, the manufacture of ink 22 in batches of no more than 200 grams has been found to be key in providing a fresh adherent and durable ink.

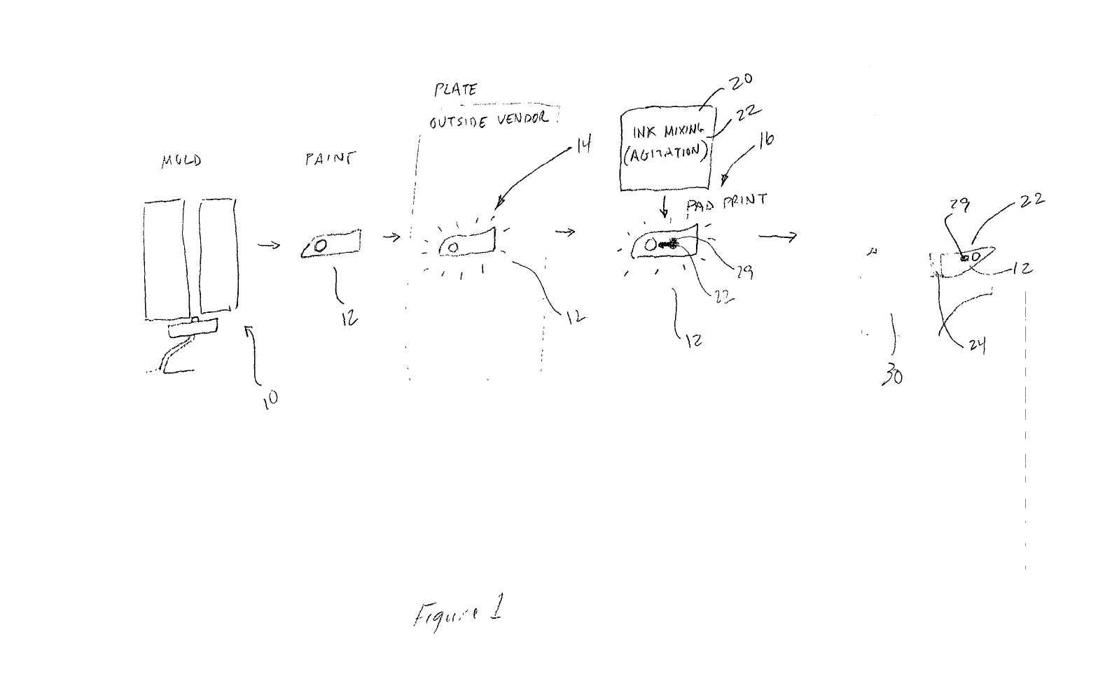

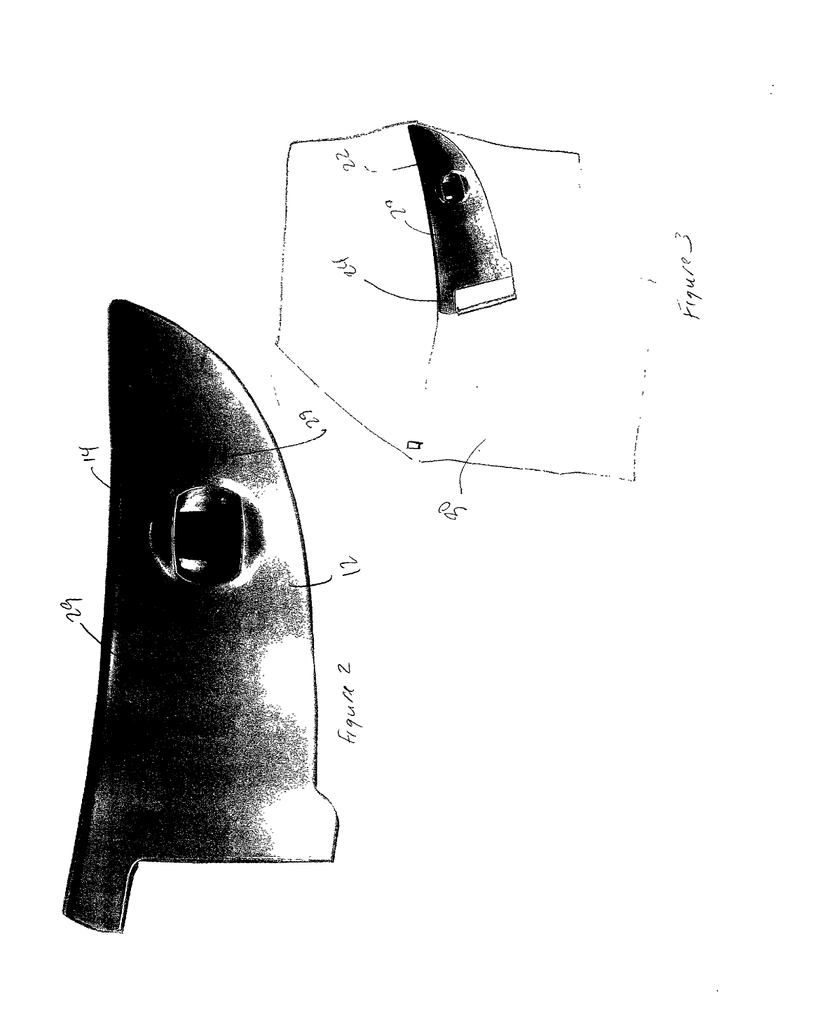

Once part 12 is printed upon, and allowed to cure, either by the natural absorption of fluids or through the use of dryers or lamps, in manners well known in the art, the part may be used in the manner desired by the manufacturer. In a preferred embodiment of the present invention, the part that is printed on is a decorative molding for use about the door lock and handle 24 area 26 of an automobile. In a preferred embodiment, part 12 is injected molded and sent to a plating contractor to be chrome plated. It is, however, to be understood that plating may be done at the site of the molding, or at any other desirable site, without departing from the novel scope of the present invention. Subsequently, part 12 is pad printed, using agitated ZK ink 22, with, in the illustrative embodiment, a key-shaped icon 29, and allowed to dry. The part is then placed onto an automobile door panel 30, as illustrated in FIGS. 1 and 3, and shipped to the automobile original equipment manufacturer for installation onto an automobile in an assembly line. It is to be understood that the present method is equally adapted to any part of an automobile, or any part of any other device, without departing from the novel scope of the present invention.

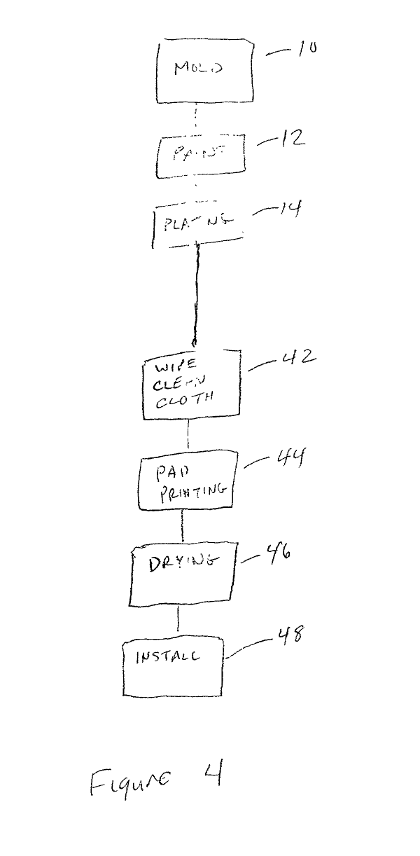

In a second preferred embodiment, as illustrated in FIG. 4, part 12 is molded and chrome plated in the manner described above. The part 12 is then cleaned with a clean cloth 42, so as to remove any residue (acquired in any step of the printing process) from part 12 and is sent to a pad printing process 44, as described above.

In a preferred embodiment of the pad printing process 42, a rubber tipped printer, of a type well known in the art, is equipped with the appropriate stamp, or die, and is pushed against a pad having agitated ink 22. The inked stamp, or die, is then placed against the surface of part 12 and is then withdrawn. The stamp or die is then pushed against the surface of part 12, a second time, to effect a second printing on the surface of part 12, giving a darker, clearer, more durable impression. The stam or die can then be wiped clean prior to further use. In one embodiment, the stamp or die is inked, placed against part 12, wiped clean, then re-inked and placed again on part 12, giving a further enhancement to the printed impression.

Once printing has been accomplished, in the second preferred embodiment, the part may be allowed to dry naturally, or may be sent through a curing process, typically by a conveyor belt, through a heating, or baking, device. In a preferred method of curing part 12, a conveyor takes the printed part in proximity to an infrared heat source for a specified time and at a specified temperature. It has been found that a temperature range of between 250° and 260° Fahrenheit, preferably 258° Fahrenheit, for between 2 and 3 minutes, preferably 2.5 minutes, produces nominal results. Such systems typically may be constructed such that an extended infrared source is placed in proximity to a conveyance system, such as a conveyor belt. The conveyor belt is of such length and moves at such speed that the printed part 12 is cured by the time it reached the end of the conveyor belt. Once cured, part 12 may be installed 48 onto an automobile or a constituent part, thereof.

Although illustrative embodiments of the invention have been shown and described, it is to be understood that various modifications and substitutions may be made by those skilled in the art without departing from the novel spirit and scope of the invention.

1. An automobile part, comprising:
a chrome plated object having industry standard printing, thereon;
said printing resulting from a pad printing process using ink that has been agitated.

2. The automobile part of claim 1, wherein said part is manufactured of plastic in a molding process.

3. The automobile part of claim 1, wherein said ink is ZK ink, comprised of 60% ink and epoxy and 40% hardening agent.

4. The automobile part of claim 3, wherein said ink is mixed in batches of 200 grams.

5. The automobile part of claim 1, wherein said pad printing process includes the use of a pad and a stamp, having indicia, and said stamp is inked on said pad and pressed against said part, to print on said part, immediately after agitated ink has been placed on said pad.

6. A method of printing on an automobile part, comprising the steps of:
producing an automobile part;
plating the automobile part with chrome;
providing a stamp having indicia cut therein;
providing ink;
applying ink to said stamp and pressing said stamp onto said part.

7. The method of printing of claim 6, including the step of agitating said ink prior to applying said ink to said stamp and applying said stamp to said part.

8. The method of printing of claim 6, including cleaning the surface of the item to be printed with a clean cloth.

9. The method of printing of claim 8, including the steps of heating the printed object for a predetermined period of time at a predetermined temperature.

10. The method of printing of claim 9, wherein the predetermined temperature is 258 degrees Fahrenheit.

11. The method of printing of claim 9, wherein the predetermined time is 2.5 minutes.

12. A method of printing on an automobile part, comprising the steps of:
producing an automobile part;
bathing the item to be printed in acid to etch its surface;
cleaning the surface of the item to be printed with a clean cloth;
plating the automobile part with chrome;
providing a stamp having indicia cut therein;
providing ink;
agitating said ink;
applying ink to said stamp and pressing said stamp onto said part, and;
heating the printed object for a predetermined period of time at a predetermined temperature.

13. The method of printing of claim 12, wherein the predetermined temperature is 258 degrees Fahrenheit.

14. The method of printing of claim 12, wherein the predetermined time is 2.5 minutes.
